(19) United States
(12) Patent Application Publication
(10) Pub. No.: US 2009/0295713 A1
(43) Pub. Date: Dec. 3, 2009

(54) POINTING DEVICE WITH IMPROVED CURSOR CONTROL IN-AIR AND ALLOWING MULTIPLE MODES OF OPERATIONS

(76) Inventors: Julien Piot, Rolle (CH); David Tarongi Vanrell, Romanel sur Lausanne (CH); Olivier Egloff, Renens (CH); Greg Dizac, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/130,883

(22) Filed: May 30, 2008

(51) Int. Cl. G09G 5/00

(52) U.S. Cl. 345/156

(57) ABSTRACT

Cursor resolution of a device is based upon a user's gripping (or squeezing) of the device in one embodiment, in accordance with a user's natural usage patterns. In one aspect, a device in accordance with an embodiment of the present invention offers multiple modes of operation depending on its orientation (e.g., which side of the device is facing upward). A device in accordance with an embodiment of the present invention can be used as a mouse, a presentation device, a keyboard for text entry, and so on. In one aspect of the present invention, circular gesture based controls are implemented, specifically for repetitive type functions.

### CROSS-REFERENCES TO RELATED APPLICATIONS

This application is related to co-pending application Ser. No. 11/356,386 entitled “Dead Front Mouse” which was filed on Feb. 15, 2006, which is hereby incorporated herein in its entirety.

This application is related to co-pending application Ser. No. 11/455,230 entitled “Pointing Device for Use in Air with Improved Cursor Control and Battery Life” which was filed on Jun. 16, 2006, which is hereby incorporated herein in its entirety.

### BACKGROUND OF THE INVENTION

1. Field of the Invention

The invention relates generally to input devices, and more particularly, to improving handling and battery life of a mouse which can also be used in-air.

2. Description of the Related Art

The personal computer (PC) is increasingly becoming a media center, which user uses to store and play music, videos, pictures, etc. As a result, the PC is also increasingly seen in the living room. Users are often in more relaxed positions (e.g., lounging on a couch) when in the living room, or more generally, when interacting with media (such as when watching a video), than when using the PC for more traditional interactions. Apart from being in a more relaxed position, the user is often not close enough to a desk to rest a mouse on it.

Use of pointing devices such as mice or trackballs (sometimes called planar tracking control devices) with a PC has become ubiquitous. Since such input devices can only function when placed on a work surface (e.g., a desk or a mouse pad), they are not optimal for use with living room media delivery. Some attempts have been made at creating input devices which work freely in the air, and also work as more traditional input devices when placed on a surface. The most intuitive interface is to map the system orientation changes (e.g., yaw and pitch) into x and y cursor displacements. FIG. 1, from Logitech U.S. Pat. No. 6,069,594, illustrates yaw, pitch and roll. Some available “in-air” devices measure the changes in these orientations (yaw, pitch, and/or roll) when the user moves the device, and use these to change the position of a cursor appearing on a computer screen or media player screen. For example, the cursor on the screen moves by an amount that is a function of the yaw and pitch change. In its simplest form, the cursor position change is proportional to the orientation angle change, for example 20 pixels cursor movement results from a 1° angle change or increment. In some available devices, yaw controls the x-coordinate and pitch controls the y-coordinate. More elaborate methods, not described here, apply some non linear function on the estimated yaw, pitch, and/or roll.

Several patents and publications describe detection of movement in 3D and/or detection of movement in air, and using this detected movement to control cursor movement on an associated display. U.S. Pat. No. 5,543,758 describes a remote control that operates by detecting movement of the remote control in space including detecting circular motions and the like. U.S. Pat. No. 6,104,380 describes a control device for controlling the position of a pointer on a display based on motion detected by a movement sensor. U.S. Pat. No. 5,554,980 describes a mouse that detects 3D movement for controlling a cursor on a display. U.S. Pat. No. 5,363,120 claims a system and a method for a computer input device configured to sense angular orientation about a vertical axis. The detected orientation is used to control a cursor position on a screen. U.S. Pat. No. 4,578,674 shows a wireless (ultrasonic) pointer that can also be operated in 3 dimensions. Also, U.S. Pat. No. 4,796,019 shows a wireless handheld pointer to control a cursor by changing angular position using multiple radiation beams. IBM Technical Disclosure Bulletin Vol. 34, No. 11 describes a Gyroscopic Mouse Device that includes a gyroscope that is configured to detect any movement of a mouse to control a cursor on a display. U.S. Pat. No. 5,898,421 describes a gyroscopic mouse method that includes sensing an inertial response associated with mouse movement in 3D-space. U.S. Pat. No. 5,440,326 describes a gyroscopic mouse configured to detect mouse movement in 3D-space, such as pitch and yaw. U.S. Pat. No. 5,825,350 describes a gyroscopic mouse configured to detect mouse movement in 3D-space. U.S. Pat. No. 5,448,261 describes a mouse configured to move in 3D space. U.S. Pat. No. 5,963,145, U.S. Pat. No. 6,147,677, and U.S. Pat. No. 6,721,831 also discuss remote control orientation. U.S. Pat. No. 6,069,594 shows a mouse that moves in 3 dimensions with 3 ultrasonic, triangulating sensors around the display. U.S. Published Application 20050078087 is directed to a device which acts as a mouse for a PC when on a surface, detects when it is lifted, then acts as a remote control for appliances. U.S. Published Application 20022040095317 also discloses a remote control that can be used to control a television and a computer system.

An in-air device has also been described in co-pending application Ser. No. 11/455,230, which is assigned to the assignee of the present invention, and which is hereby incorporated by reference herein in its entirety.

The currently available in-air devices have several limitations, some of which are described below.

### Need for Re-Centering:

For planar pointing devices such as mice, the cursor position change is proportional to the device position change. Depending on the initial device position, tracking cumulative error, and so on, the device may be positioned so that no further position change is physically possible. Examples of such situations include the device being very close to the edge of the work surface (e.g., desk), the user's arm being excessively stretched, etc. For planar devices, the operation to restore the device in a position where such a situation is corrected is often called skating. Skating consists of lifting the mouse, and repositioning it in a more adequate position, for example away from the desk edge. An important property of the skating process is the ability of the mouse to detect that it is lifted and then block any cursor movement commands. This allows proper device repositioning without any cursor position change while the mouse is lifted. Once experienced a few times, the skating operation is so intuitive that no further explanation is necessary.

For in-air operation also, an equivalent motion limitation can occur—for instance, when the hand position does not allow any incremental orientation change. Angular extents of the wrist, fore-arm or arm are limited for anatomical reasons. When a physical limit is reached, completion of the pointing task is not possible. Hence, even in the case of in-air devices, there is a need for the user to reposition easily and intuitively the in-air mouse orientation so that both a comfortable position and a corresponding cursor position are attained.

### Need for Controlling Device Resolution During Varied Tasks:

Let us turn to the need for controlling device resolution during varied tasks. One of the fundamental functionalities of a pointing device is the point-and-click mechanism. The cursor is moved until it reaches a particular location (e.g., an icon on a display associated with the computer), and then the user clicks upon it to trigger some action. Other functionality typically associated with such pointing devices includes drag-and-drop. Here an object is selected by clicking a button on the pointing device while the cursor is positioned on the object, moved while the button is maintained pushed, and then dropped by releasing the button when the destination has been reached. For such fundamental functionalities, allowing the user to easily click at a precise location is very important. Clicking at a precise location with an in-air device is problematic. To begin with, controlling the movement of the cursor accurately is difficult because holding the device in the air makes complete control of orientations difficult. Further, changes in the device orientation and/or location will, by design move the cursor, and so will the parasitic motion generated by the hand when clicking. Typically, such parasitic motion results in a missed click. (The operating system on the host to which the device is coupled often suppresses a click when the cursor is not steady over its target or when the cursor is no longer on the icon at button release). Moreover, there is an inherent trade-off in in-air devices—given the limited angle span of a human wrist, fore-arm, or arm, a large resolution is needed in order for the user to easily reach any area of interest in the entire screen with a single wrist movement; however having too large a resolution would result in random cursor movements attributable to normal tremor of human hands and parasitic clicking motion. Hence there is a need for an easy and intuitive method to adjust resolution depending on desired task (for example reaching an area of interest or clicking on a tiny icon).

Previously proposed solutions for the above-described problems have significant limitations. For instance, Some existing solutions, such as the one from Thomson's Gyration Inc. (Saratoga, Calif.), require the user's to take a specific action each time when he wants the device to operate in air. For example, a specific button (trigger) may be used, the state of which can indicate whether to make the in-air tracking mechanism active. Such solutions address the problem of clicking in a specific location by simply exiting the in-air cursor control mode when clicking any buttons. When a user wants to click in a specific location, he releases the trigger button mentioned above, so that the movement of the device in air no longer translates into cursor movement. He then clicks on the button, thus eliminating any parasitic motion problems. The user will then have to click on the trigger button again to enter in-air cursor control mode to continue moving the cursor in air. Such pre-existing solutions result in a cumbersome, complicated and non-intuitive interaction of the user with the user interface.

Another solution is described in co-pending application Ser. No. 11/455,230 which is incorporated by reference herein in its entirety. This solution employs the use of a “smart” button, where the presence of the user's finger on the button is detected, and the resolution of the cursor is changed. In one case, the change in resolution is based upon the presence of the user's finger on the smart button, and/or on the pressure exerted by the user's finger on the smart button. While this solution overcomes several of the problems discussed above, this solution also presents some drawbacks. For instance, in order to simply re-center the cursor, the user would needlessly have to engage the smart button. Additionally, the user would need to exert a significant amount of pressure on the button to completely freeze the cursor movement, as would be required in the case of a re-centering. Furthermore, for certain applications (e.g., presentations) where the non-movement of the cursor is often required, such a solution requires the user to continually exert pressure on the smart button.

Existing devices also suffer from the reduced battery life that results from moving the device unintentionally over an extended period of time, for example by holding the device while watching a movie or listening to music. Once again, some existing systems address this problem by requiring a trigger button to be pressed for the device to enter the in-air mode. When the trigger button is not pressed battery power is not consumed even if the device is moved around unintentionally in air. However, such a trigger button makes the system less intuitive to use.

### Need for Multiple Modes of Operation:

Users use computers for various purposes, and for running various software applications. Depending upon the particular use and/or the specific application being run, different control devices, such as a presenter device, a keyboard device, a mouse, etc. may be required. For instance, for presentation applications a presenter device is needed to launch the presentation and to control next slide, without moving the cursor so as not to distract the audience. At some time during the presentation, a mouse type device may be required to apply cursor control either to highlight elements similar to a laser bright spot, or to annotate by underlining or color painting. Similarly for web browsing applications, a mouse is needed to click upon links so as to navigate into content, while a keyboard may be required at other times to enter text when more specific information is needed, such as typing in a word to be translated or typing in an URL address. Switching from one type of device to another is time consuming and unpleasant for the user. Hence there is a need for a device which can seamlessly change its mode of operation so as to provide various modes of operation such as cursor control, presentation control, text entry, etc.

### Need for Intuitive Gesture Controls:

In some embodiments of the present invention, providing application controls via intuitive gestures is implemented. In some embodiments, these controls and/or gestures are specific to the mode of operation of the device.

Some previous proposals for gesture driven controls are known. For example, co-pending application Ser. No. 11/455,230, which is incorporated herein by reference in its entirety, discusses several such gesture based controls. However, there is still need for more intuitive gesture controls, especially in situations where recurrent gestures are common. Such examples include scrolling through multi-media lists (e.g., lists of songs), browsing through several pages, etc.

There is thus a need for an in-air pointing device where the user, when he/she so desires, can easily and intuitively move the device without translating its movement into that of the cursor. Further, there is a need for an in-air pointing device which can facilitate clicking at a desired location in an easy and intuitive manner. Further still, there is a need for an in-air device which can effectively reduce power consumption. Moreover, there is a need for a non-cumbersome in-air pointing device which can operate in multiple modes. Also there is a need for easy and intuitive gesture based controls.

### BRIEF SUMMARY OF THE INVENTION

The present invention is an apparatus and method for improved cursor control in a device which operates in-air.

In one embodiment of the present invention, cursor resolution is based upon the user's gripping (or squeezing) of the device and/or a handle on the device. In one embodiment, when the user grips the device lightly, there is no cursor movement corresponding to the movement of the device. Such a scenario is intuitive and useful when the user is simply holding the device in his hand, but not desiring to move the cursor. When the user intends to move the cursor, he/she will intuitively hold the device more firmly, thus resulting in an increased grip/squeeze. In one embodiment, such increased squeezing will result in moving the cursor based upon the movement of the device. When the cursor reaches the position on the display where the user wishes to take some action (e.g., click on an icon), the user intuitively further tightens his/her grip on this device. In one embodiment, after a certain threshold, the cursor resolution is reduced as the user engages with the device (e.g., by tightly gripping the device), leading to more precise movement closer to the target, as well as reduced parasitic and other unintentional motion of the cursor during clicking.

The cursor freezing and resolution aspects discussed above also lead to increased battery life in accordance with one aspect of the present invention.

In one aspect, a device in accordance with an embodiment of the present invention offers multiple modes of operation depending on its orientation (e.g., which side of the device is facing upward). A device in accordance with an embodiment of the present invention can be used as a mouse, a presentation device, a keyboard for text entry, and so on. In one embodiment, the current mode of the device depends on its specific orientation.

In one aspect of the present invention, gesture based controls are implemented, specifically for repetitive functions. In particular, circular gestures using the device are implemented.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The invention has other advantages and features which will be more readily apparent from the following detailed description of the invention and the appended claims, when taken in conjunction with the accompanying drawing, in which:

FIG. 1 is a block diagram of a device in accordance with an embodiment of the present invention used with a host system.

FIG. 2A shows the top view of a device in accordance with an embodiment of the present invention.

FIG. 2B shows a cross-section (top view) of a device in accordance with an embodiment of the present invention with the trigger handle at rest position.

FIG. 2C shows a cross-section (top view) of a device in accordance with an embodiment of the present invention with the trigger handle being squeezed.

FIG. 3 is a graph of the scaling factor used to obtain cursor movement plotted against the squeezing force applied upon the handle, in accordance with an embodiment of the present invention.

FIG. 4A shows one example of the bottom side of the device in accordance with an embodiment of the present invention.

FIG. 4B shows another example of the bottom side of the device in accordance with an embodiment of the present invention.

FIG. 5 illustrates an approximately circular motion of the device created by the user, plotted on an X-Y axis.

FIG. 6A illustrates the X and Y axes positions readings with successive single step increments and decrements for a whole clock wise circle, starting from 0° position, in accordance with an embodiment of the present invention.

FIG. 6B illustrates the X and Y axes positions readings with successive single step increments and decrements for a whole counter-clock wise circle, starting from 0° position, in accordance with an embodiment of the present invention.

FIG. 7 shows the ratchet count being the number of times the device passes by the position 180°, in accordance with an embodiment of the present invention.

FIG. 8 shows a virtual keyboard application on a display associated with a host.

### DETAILED DESCRIPTION OF THE INVENTION

The figures (or drawings) depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein.

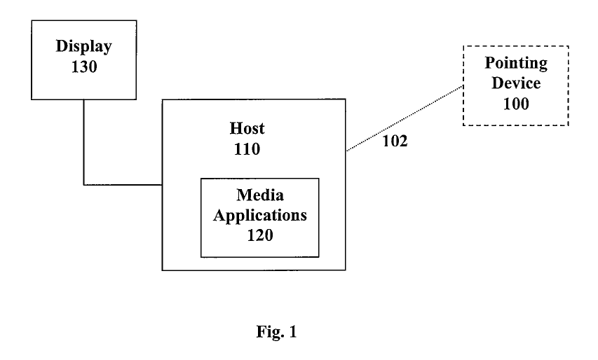

FIG. 1 is a block diagram of a pointing device 100 used with a host system 110 with media applications 120, an associated display 130.

The pointing device 100 is a device in accordance with an embodiment of the present invention, and is described in further detail below.

The host system 110 is a conventional computer system, that may include a computer, a storage device, a network services connection, and conventional input/output devices such as a mouse, a printer, and/or a keyboard, that may couple to a computer system. The computer also includes a conventional operating system, an input/output device, and network services software. In addition, in some embodiments, the computer includes Instant Messaging (IM) software for communicating with an IM service. The network service connection includes those hardware and software components that allow for connecting to a conventional network service. For example, the network service connection may include a connection to a telecommunications line (e.g., a dial-up, digital subscriber line (“DSL”), a T1, or a T3 communication line). The host computer, the storage device, and the network services connection, may be available from, for example, IBM Corporation (Armonk, N.Y.), Sun Microsystems, Inc. (Palo Alto, Calif.), Apple Computer, Inc. (Cupertino, Calif.), or Hewlett-Packard, Inc. (Palo Alto, Calif.). It is to be noted that the host system 10 could be any other type of host system such as a PDA, a cell-phone, a gaming console, a media center PC, or any other device with appropriate processing power.

The host system 110 includes media applications 120. Examples of such a media application are iTunes from Apple Computer, Inc. (Cupertino, Calif.), and Media Player or Media Center from Microsoft Corp. (Redmond, Wash.). In one embodiment, the media applications 120 are not residing on the host system 110, but rather on a remote server. The host system 110 communicates with these media applications on the remote server via a network connection. The media applications 120 are examples of applications that are controlled by the device 100 in accordance with embodiments of the present invention.

In one embodiment, the display 130 is part of the host system 110. In another embodiment, the display 130 can be a separate monitor. Such a separate monitor can be available, for example, from Sony Corp. (Japan), or Royal Philips Electronics (the Netherlands). Alternately, the pointing device itself could have a display which is controlled by movement of the pointing device and/or buttons.

In one embodiment, the connections 102 from the pointing device 100 to the host system 110 are wireless. Such wireless connections can use any wireless technology, such as BlueTooth, RF, IR, etc. In one embodiment, the connections 102 from the pointing device 100 to the host system 110 are wired. Further, in one embodiment, the connections 102 are bidirectional. In another embodiment, the connections 102 are unidirectional. Similarly, connection 112 between the host system 110 and the display 130 can also be wired or wireless in different embodiments. In other embodiment, the display 130 is integrated into the host system 110 (e.g., in the case of a laptop).

### Re-Centering the Cursor & Controlling Resolution During Varied Tasks:

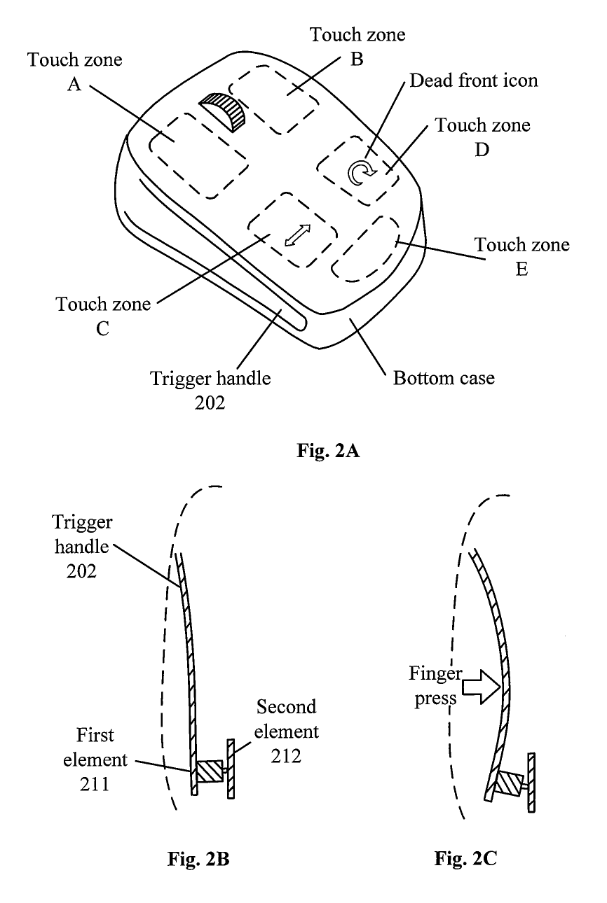

FIG. 2A shows the top view of a device 100 in accordance with an embodiment of the present invention.

The device 100 includes several touch zones 210, shown as touch zones A, B, C, D and E. In one embodiment, the touch zones A . . . E can detect a touch by using one or more detection/sense electrodes below the case surface of the device 110. Some of these touch zones (e.g., touch zone D) can be dead front zones. In one embodiment, such dead front controls (such as buttons or touch zones) on the device 100 are only visible when they are usable. For instance, certain buttons may be equipped with one or more LEDs, which light up when the device 100 enters a specific operational mode (e.g. mouse mode, presentation mode, etc.)—only then do these buttons and/or the icons on them become visible. This prevents cluttering of the device 100 with too many buttons in any mode, and thus reduces user confusion. This is described in greater detail in co-pending application Ser. No. 11/356,386, entitled “Dead Front Mouse” which is assigned to the assignee of the present invention, and which is hereby incorporated by reference in its entirety.

There is a trigger handle 202 on a pointing device 100 in accordance with an embodiment of the present invention. In accordance with an embodiment of the present invention, the trigger handle 202 is located laterally on the mouse, easily grabbed when the device 100 is held in the air.

The trigger handle 202 can be implemented in various ways to sense the pressure applied by a user. For instance, in one embodiment, when the trigger handle 202 is squeezed, a first element 211 pushes against a second element 212. FIG. 2B shows the trigger handle 202 at rest position, and FIG. 2C shows the trigger handle 202 being squeezed by a finger pressing on it. In one embodiment, the first element 211 is a mechanical finger on the handle 202, and upon the handle being squeezed, this mechanical finger 211 pushes against a force or pressure sensing resistor 212 (the second element). The resistance between resistor 212 terminals is modified by the applied force. It will be obvious to one of skill in the art that several different technologies may be used to implement the trigger handle 202. As an example, capacitive sensing between 2 electrodes plates having foam in the middle is used in accordance with an embodiment of the present invention. A description of such a capacitor with 2 electrode plates and foam in the middle can be found in co-pending application Ser. No. 12/051,975, entitled ” System and Method for Accurate Lift Detection of an Input Device”, which is assigned to the assignee of the present invention, and which is hereby incorporated by reference herein in its entirety. Other methods to detect force, pressure or movement of handle are possible, including but not limited to strain gauges, optical means including PSD (position sensing device), and so on.

In one embodiment, the trigger handle 202 is elastic, so as to allow the user to estimate degree of squeeze by feeling how much the handle 202 is being deformed. This is illustrated in FIG. 2C. In other embodiments, the trigger handle 202 is not deformed.

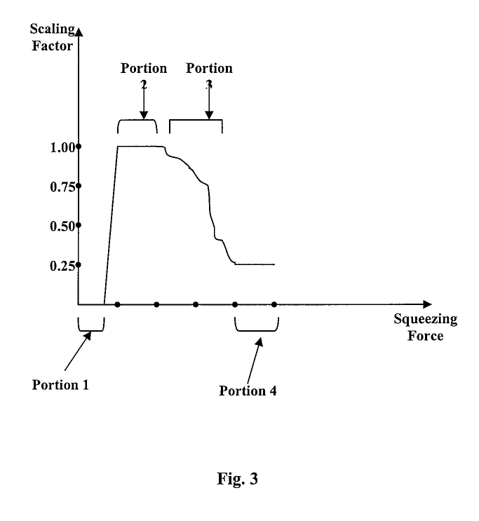

Such a trigger handle 202 provides, in accordance with an embodiment of the present invention, a very intuitive way for the user to prevent cursor movement when not desired, to re-center the device 100, and/or manage the resolution of the device 100. The usage of such a squeezing mechanism is in-keeping with a user's natural usage patterns, as discussed below with reference to FIG. 3.

It is to be noted that, in accordance with some embodiments of the present invention, the device itself has a squeeze sensing mechanism, which may not be limited to a distinct handle. In other embodiments, the trigger handle 202 exists, but is located internal to the device 100 and thus may not be visible to the user. The user experience thus is effectively that of squeezing the device 100 itself, rather than that of squeezing a handle on the device. In one embodiment, squeezing is measured at the location where the user is “gripping” the device, typically with all fingers except the thumb. The thumb is used for clicking in one such embodiment.

FIG. 3 is a graph of the scaling factor used to obtain cursor movement based upon the movement of the device 100, plotted against the squeezing force applied upon the handle 202, in accordance with an embodiment of the present invention. The detected (angular) displacement of the device is scaled by this scaling factor, and this scaled displacement is then transmitted to the host 110, in accordance with one embodiment of the present invention.

Alternatively, both the detected displacement and scaling factor can be transmitted. In this case, the scaling operation is performed by a driver in 110.

In many cases, a device 100 may be simply held by the user in his/her hand without the intention of actively using the device 100. This may happen, for example, when the user is watching a show, conducting a presentation, etc., and is simply holding on to the remote in anticipation of its use in the near future. In such a situation, the user does not desire the cursor to move based upon the movement of the device 100. Indeed, such cursor movement would not only be completely unnecessary, but would also be very distracting. To prevent such unnecessary motion of the cursor, in one embodiment, a scaling factor of zero is used when the handle 202 is not squeezed at all. This corresponds to a situation where the user is holding the device very lightly in his/her hand without squeezing the trigger handle 202, or where the fingers are not located on the handle. The scaling factor being zero in this case translates into zero cursor movement, even while the device 100 is being moved by the user. This is shown as portion 1 in FIG. 3

When the user squeezes the handle 202 slightly, the scaling factor goes to 1, thus allowing full resolution cursor movement. This is shown as portion 2 in FIG. 3. It is very intuitive for the user to grip the device 100 slightly, thus squeezing the handle 202 slightly, when a purposeful movement of the cursor is desired, say to move the cursor to a particular icon on the display 130.

As discussed above, once the user approaches the desired location on the display 130 (e.g., an icon which the user wishes to click), the resolution of the cursor movement should be decreased, so as to allow the user to accurately select the desired location. This is shown in FIG. 3 as portion 3, where the scaling factor decreases as the user squeezes the handle 202 harder. This is in keeping with a user's natural tendency to grip the device 100 harder as he concentrates on a particular task (e.g., selecting a precise location on the display). It is to be noted that the exact nature of the decrease in the scaling factor is an implementation detail which does not limit the present invention in any way.

Next, once the user has reached the desired location on the display 130, the user often wishes to click on that location (e.g., on a particular icon). As discussed above, at this time, any further cursor movement can result in “missed clicks”. We have also discussed above that this can happen due to unintentional device movement caused by the user pressing on a button on the device (e.g., to click). In accordance with an embodiment of the present invention, this can be prevented by making the scaling factor very low when the pressure on the trigger handle is further increased, as shown in portion 4 of FIG. 3. This is again in keeping with a user's natural tendency to grip the device 100 as he/she concentrates on clicking.

It will be obvious to one of skill in the art that in one embodiment, the cursor can be frozen when desired by reducing the scaling factor to zero when pressure is further increased. (This is not shown in FIG. 3.). At this point, the user can re-position the device 100 to re-center the cursor as discussed above. Alternatively, the cursor can be frozen by releasing the handle (position 0 in FIG. 3).

The cursor freezing and resolution aspects discussed above also lead to increased battery life in accordance with one aspect of the present invention. In the case of devices that operate in air, the user may unintentionally move the device, thus unnecessarily draining the battery. For instance, this could happen when the user is watching a movie or listening to music while holding the device in his hand.

In one embodiment, it is determined whether or not the user is actively controlling the cursor. If it is determined that the user is actively controlling the cursor, then the device 100 remains in a state of high power consumption. If, however, it is determined that the user is not actively controlling the cursor, then the device 100 is placed in a lower power state (for example, the idle state). In one embodiment, in a lower power state, angular displacement is not measured and transmitted. In accordance with one embodiment, whether or not the user is actively controlling the cursor is determined by the squeezing force exerted by the user on handle 202. If no squeezing force at all is detected, as in portion 1 of FIG. 3, then it is assumed, in one embodiment, that the user is unintentionally moving the device 100.

In one embodiment, power is conserved by accounting for the squeezing force applied by the user in other portions of FIG. 3. For instance, in cases when the cursor is frozen as explained above, the user is clicking on a particular icon etc. At this time, it is not necessary to track the movement of the device at all. Thus the tracking mechanism/polling for tracking can be turned off (or reduced in frequency) at this time, thus conserving battery power.

In one embodiment, when the device 100 is placed in a low power state, for example the idle state, the microprocessor in the device 100 turns off the one or more LEDs, thus indicating to the user that in-air tracking is currently disabled. Allowing the user to know when the device is active or inactive helps extending battery life as the user can adapt his usage model based on the LED indication.

In an alternate embodiment, the amount of pressure applied can control the amount of scaling of features other than a cursor, such as scrolling, changing volume or channels, zooming, etc. The movement of the device could be linear instead of angular.

### Multiple Modes of Operation

In one aspect, the present invention is a method and a system offering multiple modes of operation. A device in accordance with an embodiment of the present invention can be used as a mouse, a presentation device, a keyboard for text entry, and so on. It is to be noted that while the discussion of the particular embodiments here relates to an in-air input device, the present invention is not limited to an in-air device. For instance, where applicable, multiple modes of operation in a single device to be used on a surface is also in accordance with embodiments of the present invention.

In one embodiment, the mode of operation is dependent on the orientation of the device 100. For instance, the mode of operation of the device is dependent, in one embodiment, on which side of the device is facing upward. Changing the mode of operation of the device 110 by turning it upside/down the device requires no training for the user, and effectively makes a dual device within a tiny form factor. Alternately, the device could be pyramid shaped with 3 sides, with 3 surfaces for 3 functions (e.g., mouse, presenter, keyboard). Or, the surfaces could be other than flat, and not be exactly opposite.

In one embodiment, the device 100 includes an inclinometer. This is described in detail in co-pending application Ser. No. 11/455,230, which is incorporated by reference herein in its entirety. The inclinometer provides information regarding whether the device 100 is facing up or down (the orientation of the device). For example, when the inclinometer uses a 3-axis accelerometer, the device is detected as facing up when the detected direction of gravity is somewhat aligned with the expected direction of gravity in the given configuration.

We have seen in FIG. 2A, the top-view of a device 100 in accordance with an embodiment of the present invention. In accordance with an embodiment of the present invention, when the device is used top-side up, it functions as a mouse for a host 110 to which it is communicatively coupled. In one such embodiment, touch zones A and B function as conventional left click and right click buttons. A scroll wheel is also shown. Touch zones D, E, and F, when present, have other functionalities, such as horizontal scrolling, moving to the next page, and so on. In accordance with an embodiment of the present invention, one or more of these touch zones can also be dedicated gesture buttons, as discussed in greater detail in co-pending application Ser. No. 11/455,230, which is incorporated by reference herein in its entirety. Some specific gestures are also discussed below. The specific functionalities associated with these various touch zones can be customized by the user, in accordance with an embodiment of the present invention.

As mentioned above, in accordance with an embodiment of the present invention, the device 100 functions as a different type of input device and/or enters a different mode of operation when it is turned around. In one embodiment, the buttons and/or touch zones relating to a different mode of operation light up and/or become visible to the user only when the device is in the specific mode, and the buttons are therefore usable.

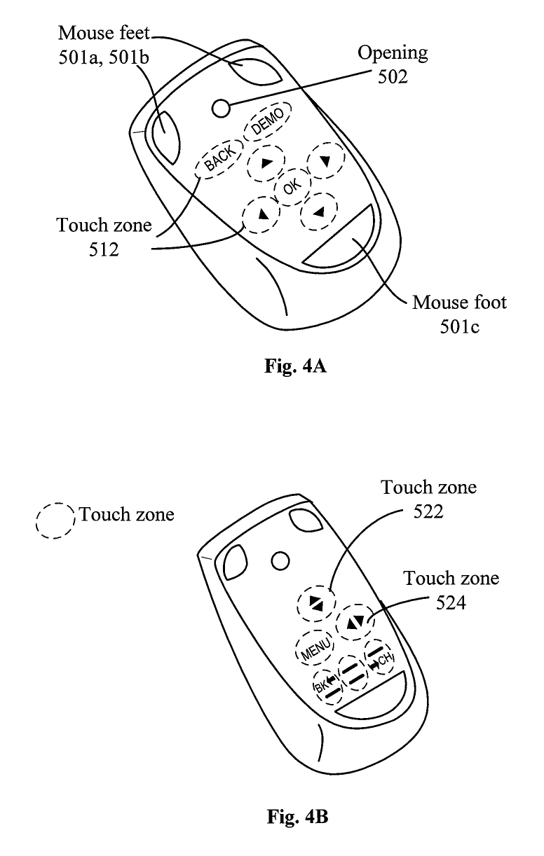

FIG. 4A shows one example of the bottom side of the device 100 in accordance with an embodiment of the present invention. In the embodiment shown, the device 100 includes feet 501a, 501b and 501c. In the embodiment shown, the device 100 includes an opening 502, through which light can be emitted and/or received. It is to be noted that such features (e.g., feet, opening) are optional, and the device 100 may not have these. For instance, the device 100 may be a continuous base device which does not have any openings. The device 100 also includes seven touch zones 512, including 4 arrow keys, an OK zone, a back key and a menu key.

In the example shown, in this mode the device 100 operates as a mini-keyboard. Such a keyboard entry mode is particular useful because a common usage environment of a device 100 is a living room. In this environment, many users do not want to have a bulky keyboard. The provided minimal set of keys allows navigation in many media applications, such as Media Center in Windows from Microsoft (Redmond, Wash.).

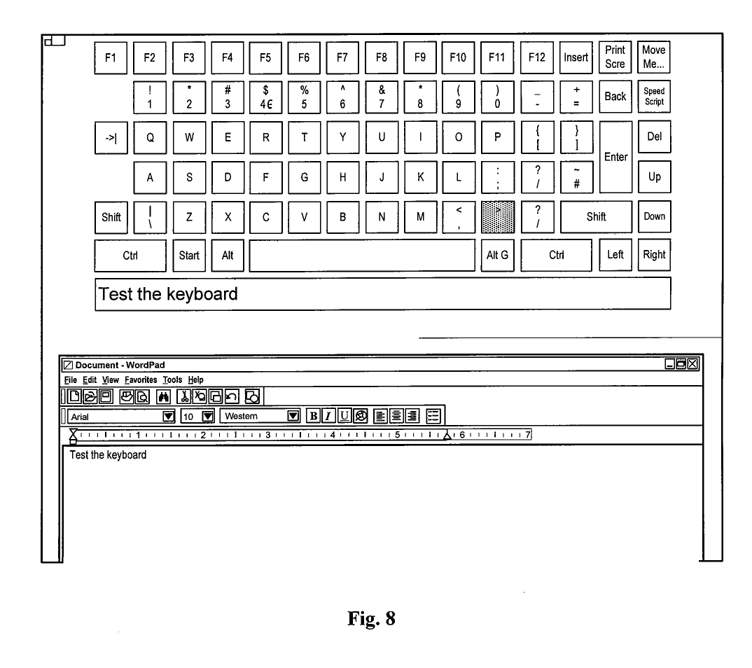

In accordance with an embodiment of the present invention, in the keyboard-entry mode, the device 100 no longer controls the cursor, but instead it controls a virtual keyboard drawn on the display. In one embodiment, when the device 100 is in the keyboard-entry state, the host 110 automatically brings up a keyboard on the display 130 (FIG. 1) in a semi-transparent way as is shown in FIG. 8. When the device 100 exits the keyboard mode, the displayed keyboard disappears from the display 130. The displayed keyboard can be used by the user to enter text etc. in the currently selected application/window active on the host 110.

In accordance with one embodiment, in virtual keyboard-entry mode, the cursor navigates from one letter to the next. In some embodiments, the selected key is zoomed in to visually indicate to the user the key that is selected. In some embodiments, the navigation from one letter to another happens without moving the cursor—the cursor is frozen in this mode in accordance with an embodiment of the present invention. In some embodiments, an audible feedback is provided at each transition from one letter to the next.

In one embodiment, the primary button accessible in this mode (e.g., the “OK” key shown in FIG. 4A) is used to click on the selected key. It is to be noted that in one embodiment, the primary button is located on the other side of the device (e.g., one of the touch zones shown in FIG. 2A).

In accordance with an embodiment of the present invention, the typing using the virtual keyboard entry mode can be sped up by using methods known in the art. One example of such a method is the method developed by SpeedScript LTD (Switzerland). In other embodiments, the typing using the keyboard entry can be sped up by using methods in accordance with embodiments of the present invention.

As mentioned above, such a virtual keyboard entry mode is entered, in accordance with one embodiment, by turning the device 110 upside down. It is to be noted that the keyboard entry mode can also be entered in other ways, in accordance with embodiments of the present invention. For instance, this mode (and/or other operational modes) can be entered by moving a ring on the device (the ring may optionally hide a secondary button), by clicking on a dedicated button with a visible feedback (led, with toggling modes), and so on.

FIG. 4B shows another example of the bottom side of the device 100 in accordance with an embodiment of the present invention. As shown in this embodiment, when the device is turned upside down, it enters a gesture recognition mode. In one embodiment, the functions triggered implemented by a particular gesture is dependent upon the button/touch zone touched by a user. For instance, in the embodiment shown, touching touch zone 522 results in translating a circular gesture by the user (moving the device in a circle while pressing button 522) into a vertical scroll movement, while touching touch zone 524 results in translating a circular gesture by the user into a horizontal scroll movement. (Several other touch zones are also shown.) It is to be noted that the movement referred to here can be any movement, such as the movement of the cursor, the movement of a particular control (e.g., increase/decrease in volume or other such controls), navigation from one letter to the next if a keyboard is displayed, and so on. Circular gestures and other gestures are discussed in further detail below.

### Gestures:

As noted above, in accordance with an embodiment of the present invention, gestures made using the device 100 can be detected by the host 110. Gesture detection mode can be a separate mode, or can be used in combination with one of the other operational modes (e.g., mouse mode, keyboard mode, etc.). In one embodiment, the gestures that can be detected include keyboard entry using graffiti-like letters. In one embodiment, gesture analysis is performed in the host 110.

The gestures that can be detected include, but are not limited to:
next/previous/back/forward/page up/page down/arrow keys, in native mode
left/right shake gestures, up/down tilt gestures, up/down shake gestures (when no tilt).
Play/Pause/Next Song/Previous Song (e.g., shakes)
Volume Up/Down (e.g., tilt)
Ok/Back/Next Channel/Previous Channel (e.g., shake)
Next Picture/Previous Picture (e.g., shakes)
Zoom Up/Down (e.g., tilt)

Many of these gestures have been described in the co-pending application Ser. No. 11/455,230, which is incorporated by reference herein in its entirety. Some other specific types of gestures are discussed below:

### Swipe Gestures:

Swipes gestures are detected by the successive detection of neighboring touch zone activations in a sequence (e.g., left to right or right to left).

### Circular Gestures:

In some embodiments, circular gestures using the device 100 are implemented. The physical limitations on movement of an input device have been discussed above in the context of re-centering of the cursor etc. Similar physical limitations exist when recurrent gestures are necessary. For instance, if volume can be changed by moving the input device up/down or right/left, there is an inherent physical limitation on how much the volume can be changed because of the limitations on how much the user's hand can move. One solution to this problem is to implement circular gestures.

In one embodiment of the present invention, a complete circle by the device 100 can be interpreted as a specific function in an application running on the host 110. For instance, a complete circle can generate an event such as “Next page” in a web browser application running on the host 110. In another embodiment, other portions of a circle, such as quarter turn rotations and half turn rotations, can be detected and interpreted as specific functions. For instance, if quarter turn rotations are detected, 4 events such as “Next page” can be generated when making a complete circle.

It is to be noted that while some of the specific embodiments discussed here refer to detection of circular gestures to generate specific events, other embodiments can be used with any input that consists of movements in 2 dimensions. In accordance with an embodiment of this invention, the optimal input for this algorithm would be the increments generated by accumulation of movement.

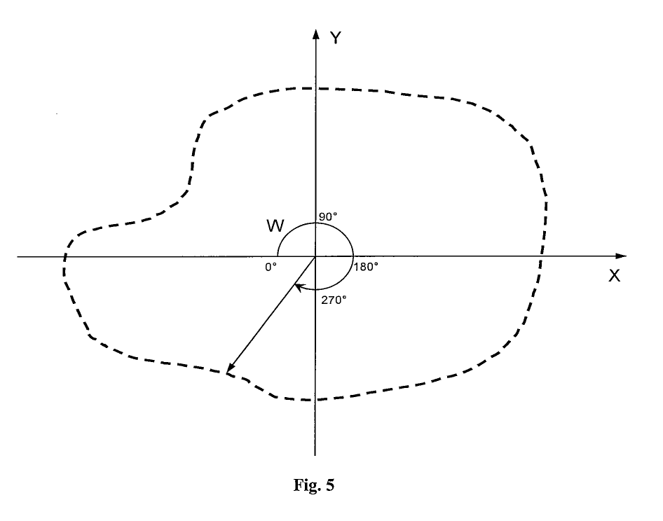

In one embodiment, using the ratchets generated from X and Y movements on horizontal and vertical axes respectively, the circle recognition algorithm generates a ratchet each time the circular movement passes the 180° point. FIG. 5 illustrates an approximately circular motion of the device 100 created by the user, plotted on an X-Y axis. A positive ratchet is generated when the movement is clockwise, and a negative one results from counterclockwise movements.

It is to be noted that the gesture to be detected here is the resulting movement of a user who wants to draw a circle. Therefore, the algorithm should be robust against the changes in circle radius as the user draws it. In one embodiment, an effective way of doing this is to consider the resulting cursor movement (X/Y) as a phasor with a variable modulus, and extracting only the phase (W). In one embodiment, the origin of phases (W=0) is located in the negative part of X axis, to be coherent with the expected gesture.

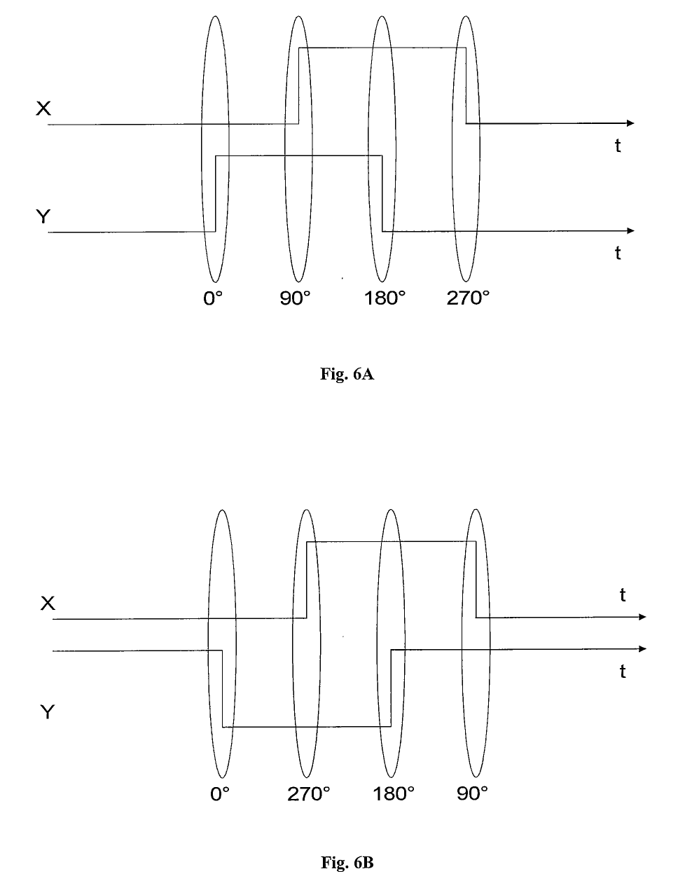

In one embodiment, the cursor positions in X and Y axes are approximated to 2 sinusoids in quadratic phase when the phasor turns. In one embodiment, in the limit case where the circle radius is a small as the smallest detectable position step, the sinusoid is transformed into a square wave, each discontinuity in the square wave being either an increment or a decrement. In one embodiment, the increments and decrements in X and Y axes positions can be counted, and the phase of the phasor estimated, as shown in pseudo-code of Appendix A: For a whole clock wise circle, and starting from 0° position, FIG. 6A illustrates the increments (dX>0, dY>0) and decrements ((dX<0, dY<0) in X and Y axes in the following sequence: “dY>0”, “dX>0”, “dY<0”, d″X<0”. For a whole counterclockwise circle, and starting from 0° position, FIG. 6B illustrates the increments and decrements in X and Y axes in the following sequence “dY<0”, “dX>0”, “dY>0”, “dX<0”. FIGS. 6A and 6B show only a series of single step increments and decrements in succession. Applying a gesture consisting of a larger circle radius will results in a more complicated succession of positions (trajectories) such as multiple positive increments on a given axis. The series of increments of a larger amplitude can be simplified to a single increment of a single step amplitude, as shown in FIGS. 6A and 6B. Hence, the direction of rotation and number of ratchets (180° phase crossings) is determined by the order in which the increments and/or decrements are observed in either axis, and is uninfluenced by the amplitude of the increment/decrement or by a succession of increments/decrements of same sign and axis. In one embodiment, if the applied circular gesture is so small that the position increments and decrements are smaller than the smallest detectable position step, the circular gesture gets unnoticed. Thus circular gestures can be made detectable as long as their amplitude is larger than the smallest step, which can be made variable by the position increment and decrement detection. In one embodiment, what makes the algorithm robust to modulus changes is that the increments in X and Y axes position as represented in the figure can be of any order—what is important is the phase between the two signals, not their amplitude.

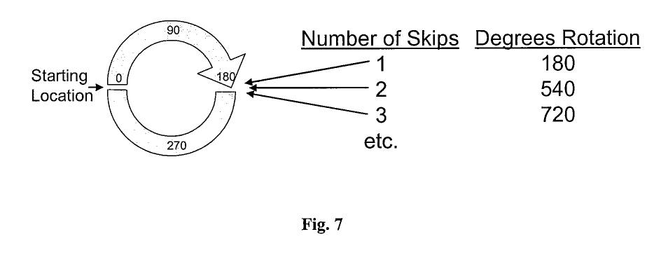

A very simple algorithm in accordance with an embodiment of the present invention, that implements the circle recognition as explained here is as follows: The ratchet count sent to the host 110 is the increment in the number of circles (‘+1’ clockwise turn, ‘−1’ counterclockwise turn). In an alternate embodiment, the ratchet count is the number of times the device 100 passes by the position 180°. This is shown in FIG. 7. A pseudo code shown in Appendix A describes the estimation of direction and ratchet based on analysis of increment polarity between X and Y axis.

While particular embodiments and applications of the present invention have been illustrated and described, it is to be understood that the invention is not limited to the precise construction and components disclosed herein. For example, where applicable, certain aspects of the present invention can be implemented in a device that works in air, on surfaces, or both in air and on a surface. As another example, touch zones have been discussed above, but conventional buttons (or a combination of touch zones and conventional buttons) can also be implemented in accordance with various embodiments of the present invention. The terms pressure and force are used interchangeably in the claims, such that a pressure sensor is intended to also include a force sensor. Various other modifications, changes, and variations which will be apparent to those skilled in the art maybe made in the arrangement, operation and details of the method and apparatus of the present invention disclosed herein, without departing from the spirit and scope of the invention as defined in the following claims.

```
APPENDIX A
if(currentCircleQuadrant == QUAD_INIT)
  {
    if(dY > 0)
    {
      clockWiseSense = TRUE;
      currentCircleQuadrant = QUAD_0_90;
    }
    else if(dY < 0)
    {
      clockWiseSense = FALSE;
      currentCircleQuadrant = QUAD_270_0;
    }
  }
  else if(currentCircleQuadrant == QUAD_0_90)
  {
    if(clockWiseSense)
    {
      if(dX > 0)
      {
        currentCircleQuadrant = QUAD_90_180;
      }
      else if(dY < 0)
      {
        clockWiseSense = FALSE;
        currentCircleQuadrant = QUAD_270_0;
      }
    }
    else
    {
      if(dY < 0)
      {
        currentCircleQuadrant = QUAD_270_0;
      }
      else if(dX > 0)
      {
        clockWiseSense = TRUE;
        currentCircleQuadrant = QUAD_90_180;
      }
    }
  }
  else if(currentCircleQuadrant == QUAD_90_180)
  {
    if(clockWiseSense)
    {
      if(dY < 0)
      {
        currentCircleQuadrant = QUAD_180_270;
        ratchet = 1;
      }
      else if(dX < 0)
      {
        clockWiseSense = FALSE;
        currentCircleQuadrant = QUAD_0_90;
      }
    }
    else
    {
      if(dX < 0)
      {
        currentCircleQuadrant = QUAD_0_90;
      }
      else if(dY < 0)
      {
        clockWiseSense = TRUE;
        currentCircleQuadrant = QUAD_180_270;
      }
    }
  }
  else if(currentCircleQuadrant == QUAD_180_270)
  {
    if(clockWiseSense)
    {
      if(dX < 0)
      {
        currentCircleQuadrant = QUAD_270_0;
      }
      else if(dY > 0)
      {
        currentCircleQuadrant = QUAD_90_180;
        clockWiseSense = FALSE;
      }
    }
  else
    {
    if(dY > 0)
      {
        currentCircleQuadrant = QUAD_90_180;
        ratchet = −1;
      }
      else if(dX < 0)
      {
        currentCircleQuadrant = QUAD_270_0;
        clockWiseSense = TRUE;
      }
    }
  }
  else if(currentCircleQuadrant == QUAD_270_0)
  {
    if(clockWiseSense)
    {
      if(dY > 0)
      {
        currentCircleQuadrant = QUAD_0_90;
      }
      else if(dX > 0)
      {
        currentCircleQuadrant = QUAD_180_270;
        clockWiseSense = FALSE;
      }
    }
    else
    {
      if(dX > 0)
      {
        currentCircleQuadrant = QUAD_180_270;
      }
      else if(dY > 0)
      {
        currentCircleQuadrant = QUAD_0_90;
        clockWiseSense = TRUE;
      }
    }
  }
```

What is claimed is:

1. A method for improved input function control using an in-air input device for controlling an input function on a display, the method comprising:
measuring a displacement of the in-air input device;
measuring an amount of pressure applied to the in-air input device by a user;
using the displacement of the input device to control an amount of the input function on the display; and
scaling the amount of the input function by a scaling factor based upon the measured amount of pressure.

2. The method of claim 1 wherein said input function is one of a cursor, scrolling, volume control, channel control and zoom.

3. The method of claim 1, wherein the step of measuring the amount of pressure applied to the in-air input device by a user comprises measuring pressure exerted by the user's hand on a trigger handle in the in-air pointing device.

4. The method of claim 1, wherein the step of scaling comprises:
responsive to the pressure being less than a first threshold, using a first scaling factor of zero;
responsive to the pressure being greater than the first threshold and less than a second threshold, using a scaling factor of one; and
responsive to pressure being greater than the second threshold and less than a third threshold, using a scaling factor decreasing with an increasing measured pressure;
wherein the first threshold is less than the second threshold, the second threshold is less than the third threshold.

5. An in-air input device for controlling an input function on a display, comprising:
a displacement sensor for measuring a displacement of the in-air input device;
a pressure sensor for measuring an amount of pressure applied to the in-air input device by a user;
a controller which receives the displacement of the input device and uses it to control an amount of the input function on the display; and
said controller scaling the amount of the input function by a scaling factor based upon the measured amount of pressure.

6. An input device operational in multiple modes, the input device comprising:
a housing having a first surface and a second surface;
a first input element on said first surface of the input device, the first input element being used to operate the input device in a first mode; and
a second input element on the second surface of the input device, the second input element being used to operate the input device in a second mode.

7. The input device of claim 6 wherein said first surface is a top surface and said second surface is a bottom surface.

8. The input device of claim 6, wherein the first and second input elements are touch zones.

9. The input device of claim 6, wherein the first input element is visible only when the input device is in the first mode and the second input element is visible only when the input device is in the second mode.

10. The input device of claim 6, wherein the input device is in the first mode in response to a determination that the first surface is facing up.

11. The input device of claim 6, further comprising:
an inclinometer for determining the orientation of the device.

12. The input device of claim 6, wherein the input device is in the second mode in response to a determination that the second surface is facing up.

13. The input device of claim 6 configured to work in air.

14. The input device of claim 13, further comprising:
a trigger handle for scaling a measured angular displacement of the input device for improved cursor control.

15. The input device of claim 6, wherein the first mode is a mouse mode.

16. The input device of claim 6, wherein the second mode is a keyboard mode.

17. The input device of claim 6, wherein the second mode is a presentation device mode.

18. A method for operating an input device in multiple modes, comprising:
orienting the input device with a first surface facing upward;
operating a first input element on said first surface of the input device, the first input element being used to operate the input device in a first mode;
orienting the input device with a second surface facing upward; and
operating a second input element on a the second surface of the input device,
the second input element being used to operate the input device in a second mode.

19. A method for user interface control in an in-air device, comprising:
measuring the number of circular rotations of the in-air device;
based upon the measured circular rotations, implementing a function in an application.

20. The method of step 19 wherein the step of implementing the function comprises:
transmitting a number of ratchet counts to a host which are proportional to the measured number of circular rotations.

21. The method of claim 20, wherein each circular rotation corresponds to one ratchet count.

22. The method of claim 19, wherein each circular rotation corresponds to four ratchet counts.

23. The method of claim 19, wherein a change in a radius of a circular rotation does not affect the number of circular rotations measured.

24. The method of claim 19, wherein the step of measuring the number of circular rotations comprises:
considering the movement of the input device as a phasor with a variable modulus; and
extracting phase information from the phasor.
